(19) United States
(12) Patent Application Publication
(10) Pub. No.: US 2013/0114956 A1
(43) Pub. Date: May 9, 2013

(54) DPSK OPTICAL RECEIVER

(71) Applicant: Jong-Hoi Kim, Daejeon (KR)

(72) Inventor: Jong-Hoi Kim, Daejeon (KR)

(73) Assignee: ELECTRONICS AND TELECOMMUNICATIONS RESEARCH INSTITUTE, Daejeon (KR)

(21) Appl. No.: 13/610,063

(22) Filed: Sep. 11, 2012

(30) Foreign Application Priority Data
Nov. 7, 2011 (KR) 10-2011-0115055

(51) Int. Cl. H04B 10/08

(52) U.S. Cl. 398/25

(57) ABSTRACT

Disclosed is a DPSK optical receiver capable of compensating for a polarization phase difference. The DPSK optical receiver according to an embodiment of the present disclosure includes: an optical splitter configured to split a received optical signal into a first optical signal and a second optical signal; an optical delay waveguide configured to delay the first optical signal; a birefringent waveguide configured to delay the second optical signal so as to compensate for a polarization phase difference at an output end; and an optical hybrid configured to generate an optical detection signal corresponding to a phase difference between the delayed first optical signal and the delayed second optical signal.

### CROSS-REFERENCE TO RELATED APPLICATIONS

This application is based on and claims priority from Korean Patent Application No. 10-2011-0115055, filed on Nov. 7, 2011, with the Korean Intellectual Property Office, the disclosure of which is incorporated herein in its entirety by reference.

### TECHNICAL FIELD

The present disclosure relates to an optical receiver used in a Differential Phase Shift Keying (DPSK) optical communication system.

### BACKGROUND

In case of a DPSK (or differential phase quadrature shift keying (DPQSK)) optical receiver, a polarization phase difference occurs due to polarization dependency of an optical medium while a received optical signal passes through an optical demodulator. FIG. 1 is a diagram showing a polarization phase difference of an output optical signal of a general optical demodulator. As shown in FIG. 1, a polarization phase difference occurs due to birefringent characteristics of a waveguide during a demodulation process of an optical signal and thus, a difference in an output spectrum thereof occurs. Therefore, in order to accurately demodulate the optical signal, there is a need to compensate for the polarization phase difference.

The related art uses a method for compensating for a polarization phase difference by controlling birefringence of a medium using an electrical phase control apparatus or inserting a half-wave plate into an middle of a waveguide to rotate a polarization direction 90°.

However, in case of using an electrical phase control apparatus as described above, there is a need to connect an electrode formed by depositing metal on an element to an external control apparatus and in case of using the half-wave plate, there is a need to mechanically or chemically etch the middle of the waveguide of the element and insert the wave-guide plate into the middle of the waveguide, and therefore, expensive elements such as metal or the half-wave plate and a complicated manufacturing process are needed. This causes degradation in production yield and an increase in manufacturing costs of the optical receiver.

### SUMMARY

The present disclosure has been made in an effort to provide a DPSK optical receiver capable of compensating for a polarization phase difference of an output optical signal without using an electrical phase control apparatus, a half-wave plate, or an external control apparatus by controlling a length or a width of a birefringent waveguide.

An exemplary embodiment of the present disclosure provides a DPSK optical receiver including: an optical splitter configured to split a received optical signal into a first optical signal and a second optical signal; an optical delay waveguide configured to delay the first optical signal; a birefringent waveguide configured to delay the second optical signal so as to compensate for a polarization phase difference at an output end; and an optical hybrid configured to generate an optical detection signal corresponding to a phase difference between the delayed first optical signal and the delayed second optical signal. In addition, the DPSK optical receiver may further include an optical detector configured to convert the optical detection signal into an electrical signal.

The polarization phase difference may be compensated by controlling a length and/or width of the birefringent waveguide.

A magnitude of the first optical signal and the second optical signal may be a half of the received optical signal.

The optical detection signal may include an inphase(I)-signal, a quadrature(Q)-signal, an inversion signal of the I-signal, and an inversion signal of the Q-signal.

According to the exemplary embodiments of the present disclosure, the manufacturing costs can be reduced by not using the electrical phase control apparatus or the half-wave plate and the price competition of the DPSK based optical communication system for ultra-high speed, large capacity optical transmission can be improved by providing the inexpensive components.

Further, since the external control apparatus for controlling the phase of the optical signal is not needed, the system management can be facilitated and the management costs can also be saved.

In addition, the optical receiver can be miniaturized and the manufacturing costs thereof can be saved, by integrating the birefringent waveguide, the optical delay waveguide, the optical hybrid, and the optical detector on the single substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing a polarization phase difference of an output optical signal of a general optical demodulator.

FIG. 2 is a configuration diagram of a DPSK optical receiver according to an embodiment of the present disclosure.

FIG. 3 is a diagram showing a change in a polarization phase difference according to a length of a birefringence waveguide.

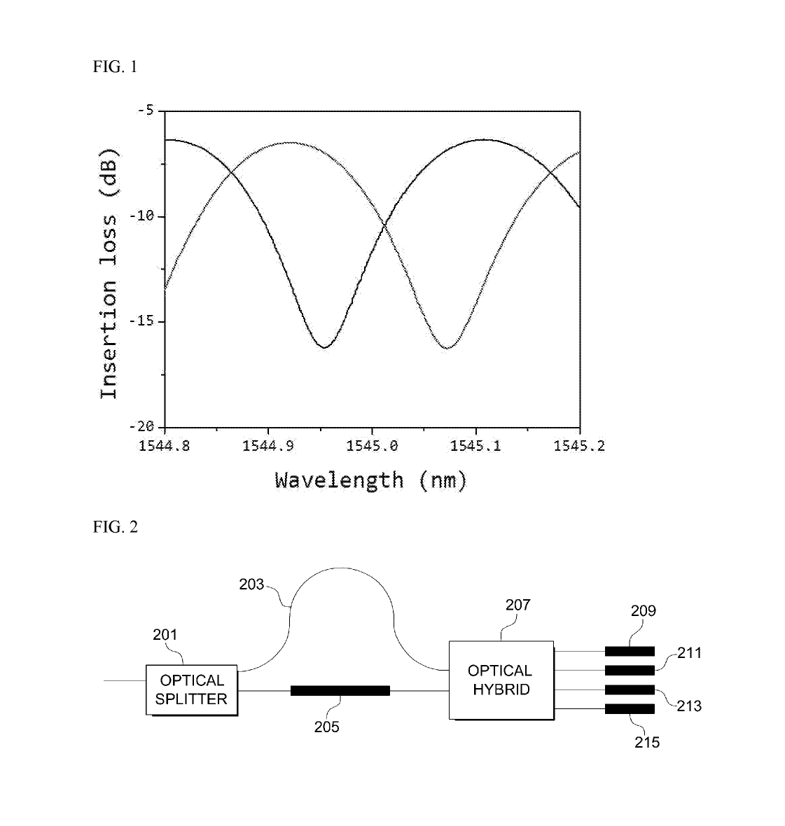

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

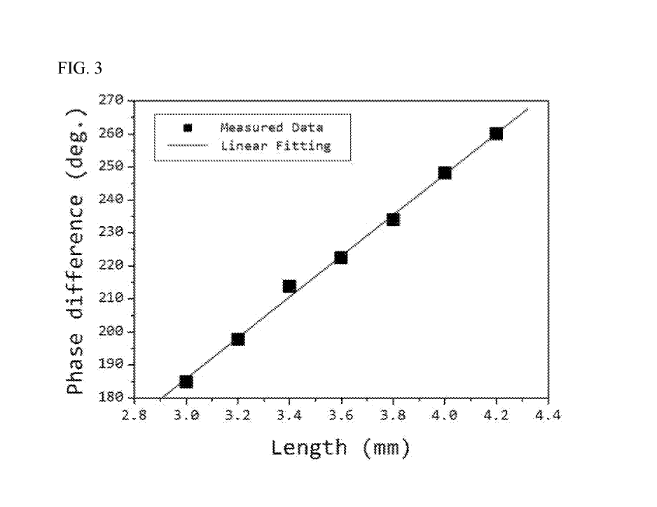

FIG. 2 is a configuration diagram of a DPSK optical receiver according to an embodiment of the present disclosure and FIG. 3 is a diagram showing a change in a polarization phase difference according to a length of a birefringence waveguide.

Referring to FIG. 2, a DPSK optical receiver according to an embodiment of the present disclosure includes an optical splitter 210 that splits a received optical signal into a first optical signal and a second optical signal, an optical delay waveguide 203 that delays the first optical signal, a birefringent waveguide 205 that delays the second optical signal so as to compensates for a polarization phase difference at an output end, and an optical hybrid 207 that generates an optical detection signal corresponding to a phase difference between the first optical signal delayed through the optical delay waveguide 203 and the second optical signal delayed through the birefringent waveguide 205. The DPSK optical receiver may further include optical detectors 209, 211, 213, and 215 that convert the optical detection signal generated in the optical hybrid 207 into the electrical signal.

The first optical signal and the second optical signal are a signal obtained by dividing the received optical signal by a half and a magnitude (amplitude) thereof is a half of the received optical signal.

The length of the optical delay waveguide 203 is larger than that of the birefringent waveguide 205 and the first optical signal delayed through the optical delay waveguide 203 is more delayed by transmission time of 1 bit than that of the second optical signal delayed through the birefringent waveguide 205. That is, the delayed first optical signal and the delayed second optical signal are input to the optical hybrid 207 at a difference corresponding to the transmission time of 1 bit.

Generally, in the DPSK optical receiver, a speed difference occurs according to vertical and horizontal polarization components when the optical signal passes through a light waveguide, such that errors occur in a phase difference value of the optical signal detected at the output end. Therefore, the embodiment of the present disclosure compensates for the polarization phase difference of the optical signal using the birefringent waveguide 205, thereby reducing the errors.

FIG. 2 shows a change in the polarization phase difference according to the length of the birefringent waveguide 205 manufactured on a Si substrate. As described above, it is possible to compensate for the polarization phase difference of the output optical signal by generating the additional polarization phase difference using the birefringent waveguide 205. For example, it is possible to additionally generate the phase difference between the vertical and horizontal polarization components of the optical signal in the birefringent waveguide 205 so that the polarization phase difference of the output optical signal is an integer multiple of 0° or 360°.

The optical hybrid 207 compares the optical signal of a bit currently input through the birefringent waveguide 205 with the optical signal of a bit input ahead of 1 bit through the optical delay waveguide 203 to generate the optical detection signal corresponding to the phase difference. Here, the optical detection signal may include an inphase (I)-signal, a quadrature (Q)-signal, an inversion signal of the I-signal, and an inversion signal of the Q-signal. The I-signal may be implemented by a cosine type of a wave signal and the Q-signal may be implemented by a sine type of a wave signal. The configuration of the optical hybrid 207, the characteristics of the optical detection signal, and the like, are widely known in the art to which the present disclosure pertains and therefore, the detailed description thereof will be omitted.

The optical detectors 209, 211, 213, and 215 convert the optical detection signal (I-signal, Q-signal, inversion signal of I-signal, and inversion signal of Q-signal generated from the optical hybrid 207 into the electrical signal. The optical receiver uses the converted electrical signal to apply the digital signal processing, thereby discriminating the received optical signal.

Meanwhile, the optical splitter 201, the optical delay waveguide 203, the birefringent waveguide 205, the optical hybrid 207, and the optical detectors 209, 211, 213, and 215 of FIG. 2 may be manufactured in a form integrated on the single substrate. Therefore, the process automation, mass production, and miniaturization can be implemented and the price competition of products can be more increased.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A DPSK optical receiver, comprising:
an optical splitter configured to split a received optical signal into a first optical signal and a second optical signal;
an optical delay waveguide configured to delay the first optical signal;
a birefringent waveguide configured to delay the second optical signal so as to compensate for a polarization phase difference at an output end; and
an optical hybrid configured to generate an optical detection signal corresponding to a phase difference between the delayed first optical signal and the delayed second optical signal.

2. The DPSK optical receiver of claim 1, wherein the polarization phase difference may be compensated by controlling a length and/or width of the birefringent waveguide.

3. The DPSK optical receiver of claim 1, wherein a magnitude of the first optical signal and the second optical signal is a half of the received optical signal.

4. The DPSK optical receiver of claim 1, wherein the delayed first optical signal is more delayed by transmission time of 1 bit than the delayed second optical signal.

5. The DPSK optical receiver of claim 1, wherein the optical detection signal includes an inphase(I)-signal, a quadrature(Q)-signal, an inversion signal of the I-signal, and an inversion signal of the Q-signal.

6. The DPSK optical receiver of claim 1, further comprising an optical detector configured to convert the optical detection signal into an electrical signal.
